(19) United States
(12) Patent Application Publication
(10) Pub. No.: US 2002/0169002 A1
(43) Pub. Date: Nov. 14, 2002

(54) Secure and accountable wireless printing system

(76) Inventors: Alyce M. Imbrie, Chicago, IL (US); David C. Picek, Roselle, IL (US); James W. Welch II, Chicago, IL (US)

Correspondence Address: Patzik, Frank & Samotny, Ltd, Suite 900, 150 South Wacker Drive, Chicago, IL, 60606, US

(21) Appl. No.: 10/137,575

(22) Filed: May 1, 2002

Related U.S. Application Data
(60) Provisional application No. 60/288,125, filed on May 2, 2001.

(51) Int. Cl. H04B 1/38

(52) U.S. Cl. 455/557; 455/41; 455/556

(57) ABSTRACT

A secure wireless printing system and method for printing data from a wireless device at a selected printing assembly while providing accountability and generating revenues from such usage. The printing assembly includes an intermediate device for receiving and processing data submitted by the wireless device. The intermediate device is connected to a printer and a validation device to ensure that the print job printed at the respective printer is received by the correct wireless device user. A print driver on the wireless device converts the print data to a universal format, negotiates the available printers; and submits a secure ID to identify the account to which the print job belongs. The intermediate device then converts the print data to a printer readable format and sends the data to the printer to be printed.

This application claims priority based on U.S. Provisional Application Ser. No. 60/288,125, filed on May 2, 2001.

### DESCRIPTION

The present invention relates to transmitting data to peripheral devices in general, and more particularly, to a print server system and method for adding secure, accountable and wireless printing capabilities to printer devices.

### BACKGROUND OF THE INVENTION

As technology continues to develop, more and more people are taking advantage of the myriad of wireless devices available. Wireless communication is desirable because it eliminates the need for a physical hard-wire connection between devices. However, problems have arisen in connecting the wireless devices to peripheral devices, such as a printer.

In particular, most peripheral devices such as printers require proprietary device drivers to be installed on the wireless or submitting device in order for the wireless device to be able to communicate with the peripheral device. Thus, in order to be able to utilize the peripheral devices, a user of a wireless device typically has to know what peripheral devices it will be using to enable it to install the proper device drivers. If the wireless device does not have the correct device driver installed, it will be unable to communicate with the printer or other peripheral device.

With the inherent portability of wireless devices, the user has the potential to encounter a larger number of different peripheral devices, wherein each peripheral device typically requires a unique device driver. While it would be beneficial to have each potential device driver stored on the wireless device, most wireless devices do not have enough memory to store or upgrade all of the device drivers necessary to support the printers or other peripheral devices they are likely to encounter.

Additionally, because wireless communications must travel through the air, problems have arisen concerning the security of wireless transaction. In particular, wireless transactions are subject to capture or eavesdropping.

For the foregoing reasons, there is a need for a system that will allow a submitting device to wirelessly and securely communicate with a multitude of differing peripheral devices.

### SUMMARY OF THE INVENTION

Using the system and method of the present invention, the user seeking to print a data file from a wireless device such as a laptop computer, Palm organizer, Pocket PC, other PDA, cellular phone, digital camera, 2 way text pager, digital camera wristwatch or the like, can approach any wireless-enabled printer and print e-mail, web pages, digital photos, maps and/or full documents. This can be done without any physical connection between the printer and the wireless device. Likewise, the user need not make decisions regarding the drivers, network privileges and/or printer capabilities. It is contemplated that the system can be used as a value-added service or as a new source of revenue at such places as print shops, photo stores, copy shops, book stores, airports, hotels, libraries and coffee shops.

The system and method of the present invention also adds security and accountability to a wireless-enabled printer. For example, security can be provided by using public key/private key encryption of the data packets being transmitted wirelessly.

The system generally includes two elements: a software component on the submitting device (e.g., the wireless device) and a hardware component attached to the printer. The software component preferably is a specialized print driver establishing itself at the presentation layer of the pertinent wireless device protocol stack. The specialized print driver handles the functions of converting print data to a “universal format” to be interpreted by the hardware component. A specialized version of XHTML can be used as a preferred format. The driver can negotiate the location, identification and capabilities of each printer within range or within the cell, as well as negotiate whether the printer is currently available. The driver could also enable submission of a secure ID so as to identify to the printer which account the data file to be printed (i.e., the print job) belongs.

The hardware component can be a stand-alone wireless print server such as a dongle that attaches to the parallel port of the printer. Other possible printer connections include USB, Fire Wire, RS-232, or Ethernet. The print server or intermediate device of the present system can also be internally mounted on the printer. In the alternative, the specialized driver can be embedded on the printer controller.

A magnetic card reader can be attached to the device via an RS-232 connection. Specialized firmware can allow the print server to perform such simultaneous functions as: converting the universal print data to a format specific to that printer; broadcasting printer properties, such as location, identification, capabilities, etc.; interfacing the magnetic card reader to validate the user's ID card; and, deducting the appropriate amount from stored-value cards, based upon the size of the print job. When a job request is submitted, the device holds the connection open while it awaits authentication via the magnetic card swipe. When the card is inserted, the ID information is confirmed against the data supplied by the driver, the data is released and, in the case of stored-value cards, the proper credits are deducted.

Among those that are believed likely to use the system are: those giving presentations at remote locations away from their home offices; airline passengers that must print the latest version of documents which have been revised while they were in the air; those attempting to work on documents while at the airport; a digital camera user; college computer labs and the like.

Revenue can be generated by charging per page printed. Likewise, as a value added to other services, such as those provided and sold by airlines, travel agents, car rental agencies, book stores, coffee shops and hotels, such printing capabilities can be sold, licensed or leased to such service providers who in turn provide such printing services to their customers or clients on a reduced charge or complimentary basis. Hotels could use a guest's room key to automatically bill that guest's account for such print charges. If a cell phone or wireless device is used to transmit the print request, the print charges can be charged to that user's wireless or cellular phone bill.

Self-standing stations providing the printing system to individuals such as kiosks, on a prepaid card, debit card and/or credit card basis, can be provided in high traffic areas such as airports, university student unions, libraries, shopping malls, coffee shops, book stores and the like, to generate revenue on the foregoing basis. Other payment systems comparable to the Mobil Speedpass® can be used as well.

The specialized driver can be embedded in the wireless device by the manufacturer of such devices. Alternatively, the wireless device user can download the driver onto the device to enable using the system. A royalty-free license arrangement may be used for the specialized driver of the system to encourage widespread adoption and use of the system.

It is, therefore, an object of the present invention is to provide a method and system for providing a secure way to allow wireless devices to communicate with peripheral devices.

Another object of the present invention is to provide a method and system for providing a secure way to allow wireless devices to print files at various printers.

A further object of the present invention is to provide a specialized print driver to allow a wireless device to communicate with a variety of printers.

A still further object of the present invention is to provide a method and system for providing accountability to the wireless transmission of print data.

A yet still further object of the present is to allow for the generation and collection of revenue from the use of printers with wireless devices.

The above objects and other features, aspects, and advantages of the present invention will become better understood with regard to the following description, appended claims, and accompanying drawings where:

### BRIEF DESCRIPTION OF THE DRAWINGS

FIG. 1 is a block diagram of a wireless printing system according to the invention illustrating a submitting device and a plurality of printing assemblies.

FIG. 2 is a block diagram of an embodiment of a submitting device of the present invention.

FIG. 3 is a block diagram of an embodiment of a printing assembly of the present invention comprising an intermediate device, a printer and a validation device.

FIG. 4 is a flow diagram illustrating the process involved in querying a selected file to print.

FIG. 5 is a flow diagram showing the steps associated with selecting a particular printer from a list of possible printers.

FIG. 6 is a flow diagram that illustrates the steps involved in submitting the print job to the selected printer.

FIG. 7 is a flow diagram showing the steps associated with spooling and validating the print job.

FIG. 8 is a flow diagram illustrating the steps involved in the printing of the print job.

FIG. 9 is a table that lists some of the various platforms, hardware, physical transports, exchange protocols, intermediate data formats, output data streams, printer attachments and billing mechanisms that may be used with the present invention.

### DETAILED DESCRIPTION OF THE INVENTION

While this invention is susceptible of embodiment in many different forms, there is shown in the drawings and will herein be described in detail, one specific embodiment, with the understanding that the present disclosure is to be considered merely an exemplification of the principles of the invention and is not intended to limit the invention only to the embodiment illustrated.

The present invention provides a method and system for allowing users of wireless devices to use foreign peripheral devices, such as printers. The method and system facilitates the use of wireless devices by allowing users to perform operations with a multitude of different peripheral devices in a multitude of different locations away from the user's own printers, while providing adequate security to the process. Although the method and system is primarily for wireless transactions, it is appreciated that the wireless device may be hardwired to the peripheral devices as well.

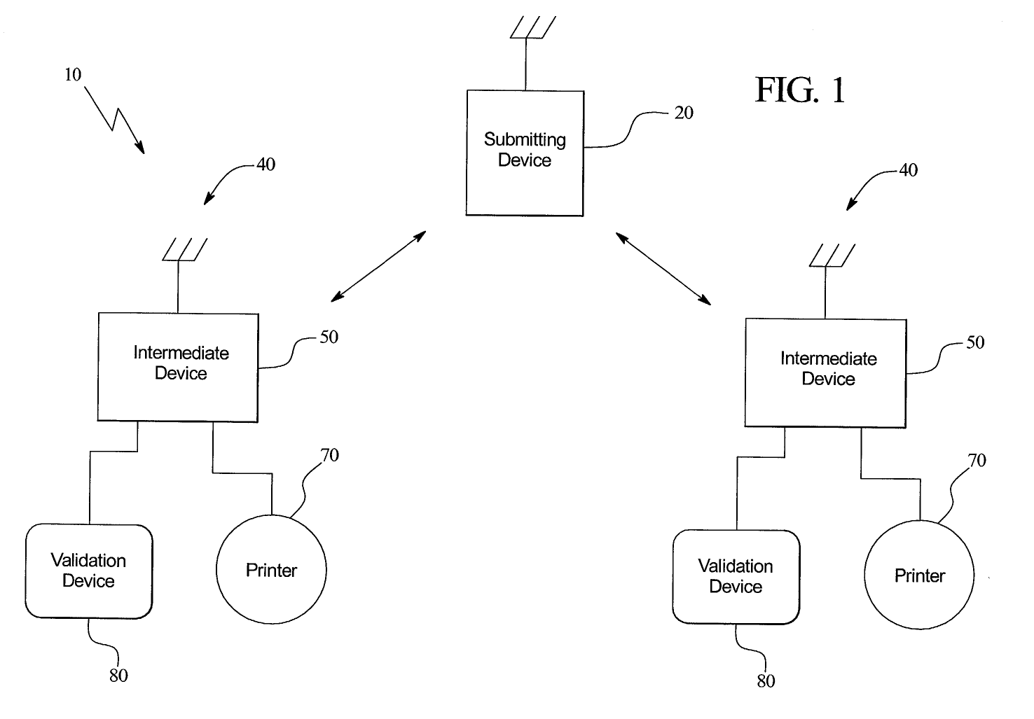

Referring now to the drawings and particularly to FIG. 1, the secure and accountable wireless printing system 10 includes a submitting device 20 and at least one printing assembly 40. Each printing assembly 40 includes an intermediate device 50, one or more printers 70, and a validation device 80. While the wireless system is shown as having a printer as the peripheral device, it is understood that other peripheral devices may be used and not depart from the present invention.

As will be explained in further detail herein, the submitting device 20 is configured to allow the submitting device to identify the location and properties of all printing assemblies 40 which are within transmission range of the submitting device 20. The submitting device 20 is further configured to permit a user to select a printing assembly 40 from the printing assemblies 40 identified by the submitting device 20, and to securely and wirelessly transmit print data to the selected print assembly 40 for printing. In addition, the submitting device 20 is further configured to convert print data to a universal or intermediate data protocol which can be recognized by any of the printing assemblies 40.

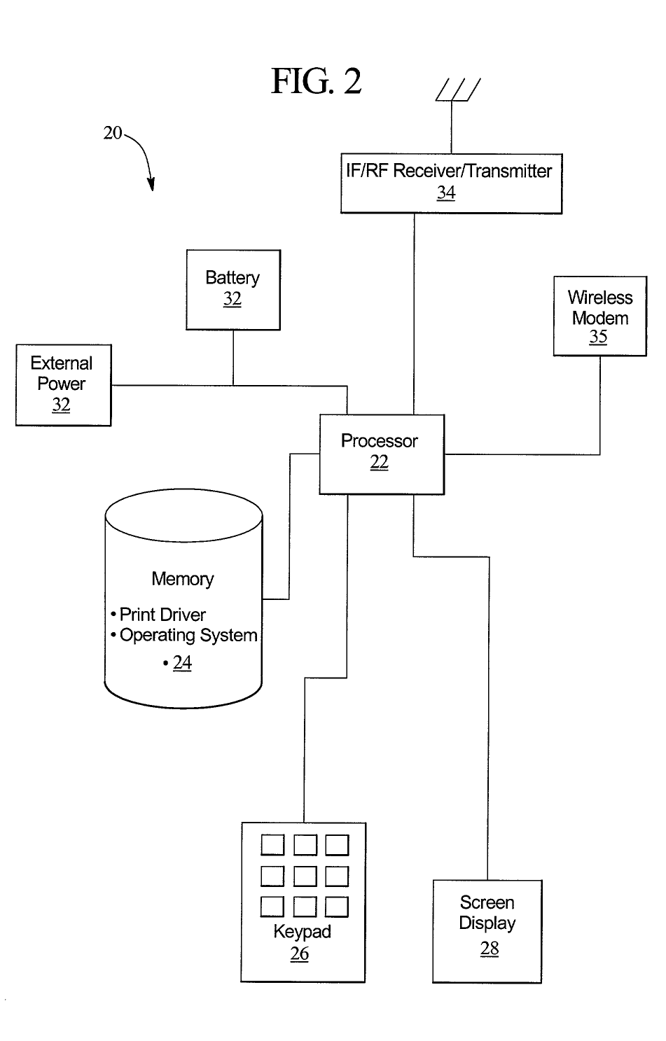

FIG. 2 is a block diagram depicting a typical submitting device 20. It is preferred that the submitting device 20 be capable of communicating wirelessly with the intermediate device 50 via an infrared (IR) or radio-frequency (RF) based transmission. However, it is appreciated that the submitting device 20 may be capable of communicating with the intermediate device 50 via a hardwired connection. Such methods of connectivity may include, but are not limited to: Bluetooth; IEEE-802.11B (Wi-Fi); 802.11A; IEEE-802.15; HiperLAN/2; SWAP; Ethernet (10/100); Token-Ring (4/16/100); USB; IEEE-1394 (FireWire); IEEE-1284 (Parallel); and RS-232 (Serial) or the like. Further, it is contemplated that the submitting device be a mobile information processing device such as a laptop computer, a “PDA” (Personal Digital Assistant), a cellular telephone, two-way text pager, a digital camera, a palmtop PC or the like. However, it is appreciated that the submitting device could be a stationary information processing unit such as a PC workstation, a desktop PC or the like.

Typically, such a submitting device includes a processor 22 for processing data stored in one or more memory portions 24 and a spooler (not shown). Stored within the memory portion 24 are one or more device drivers, including a print driver which is specially adapted for use with the present system 10; an operating system (e.g., MS Windows 95/98/ME/2000/XP; WinCE; OS/2; MacOS); and the like. To permit encryption/decryption of data received from the intermediate device, a public key can be provided and embedded within the print driver for use with a later generated private key to encrypt or decrypt data pockets transmitted from the printing assembly 40. Other encryption methods which are known to those of ordinary skill in the art should also be contemplated as being within the scope of this invention.

As further shown in FIG. 2, an input device 26 is provided which allows the user to input commands into the submitting device 20. The input device 26 may be a keyboard, a keypad or the like. A display device 28 is provided which allows the user to view visual displays produced by the submitting device 20.

Additionally, one or more power sources 32 provide the necessary operating power to the submitting device 20. Generally, such power sources 32 include a source of DC (direct current) power (e.g., a battery) and/or a source of AC (alternating current) power (e.g., a wall plug adapter). Also provided is an IR/RF receiver/transmitter 34 which allows the submitting device 20 to transmit and receive data via an RF and/or IR transmission. Alternatively, the submitting device may transmit and receive data via a wireless modem 35.

Although the operating system will vary depending upon the submitting device 20, it is contemplated that the submitting device 20 include “Plug and Play” capability, as indicated by the specifications of the corresponding physical transport layer. As will be further explained herein, this capability allows the submitting device 20 to identify and communicate with multiple printing assemblies 40. For specific applications whereby the operating system fails to provide the necessary functionality, a module shall be included to perform the required device detection.

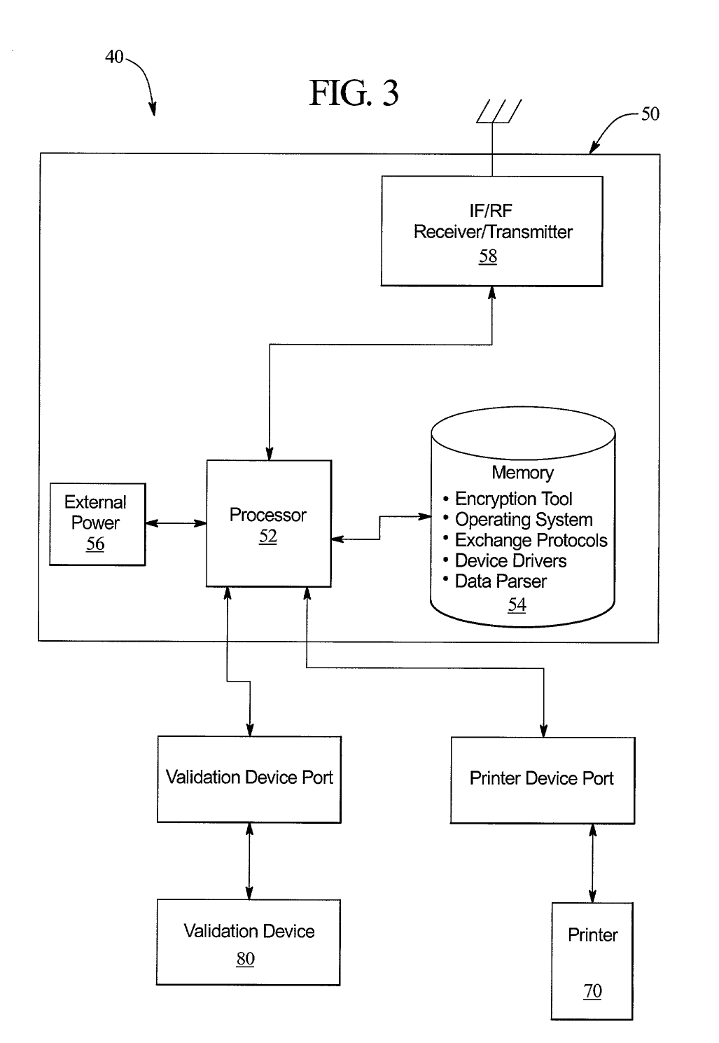

FIG. 3 is a block diagram depicting the printing assembly 40. In the preferred embodiment, the intermediate device 50, printer 70 and validation device 80 comprise separate components. However, it is appreciated that one or more of the above-noted components may be combined and not depart from the scope of the present invention. For example, the intermediate device may be contained within the printer. In addition, alternate embodiments are contemplated wherein a single validation device is connected to a plurality of intermediate device/printer combinations.

The intermediate device 50 includes a processor 52 for processing data stored in one or more memory portions 54 and for processing data received from the submitting device 20. Stored within the memory portions 54 are at least one device driver; an operating system (e.g., MS Windows 95/98/ME/2000/XP; WinCE; OS/2; MacOS); a data parser for sorting and controlling print job information; and an encryption tool capable of generating random, time-stamped private keys. A public key is also provided for decrypting encrypted data pockets received from the submitting device. In the preferred embodiment, the processor 52 is a 32-bit CISC processor operating at approximately 25 MHz. Such processors are available under the trade names m68K and i386. In one preferred embodiment, the intermediate device is a stand-alone wireless print server such as a dongle attached to the parallel port of the printer 70 and externally mounted thereto.

Furthermore, the intermediate device includes at least one power source 56. Generally, such a power source 56 includes at least a source of DC (direct current) power (e.g., a battery) and/or a source of AC (alternating current) power (e.g., a wall plug adapter). Also provided is an IR/RF receiver/transmitter 58 which allows the intermediate device 50 to transmit and receive data via an RF and/or IR transmission. While an IR/RF receiver/transmitter is shown, it is appreciated that the submitting device may connect to the intermediate device via a hardwire connection. Although many methods of connectivity may be used, the Bluetooth wireless technology is preferred as it currently has a Printing Profile in draft which is application-transparent and fully interoperable with the functionality provided by this invention. This is in parallel to the IEEE-802.11b specification, which offers superior range and throughput, where applications demand.

Connectivity between the intermediate device 50 and the printer 70 can be accomplished via an IEEE-1284 (Parallel), RS-232 (Serial), USB, Ethernet (10/100), Token-Ring (4/16/100) or other hardwired connection depending on the platform, submitting device 20 employed, and/or attachment. In addition, connectivity between the intermediate device 50 and the printer 70 can also be accomplished via a wireless connection.

Before the wireless printing system 10 will operate, a specialized print driver is loaded into the submitting device 20 at the presentation layer of the pertinent wireless protocol stack. This can be accomplished by downloading the software from a server via the Internet, by transmitting the software to the submitting device 20 via an IR or RF transmission from the printing assembly 40, or by embedding the print driver into the submitting device 20. As will be further discussed herein, the specialized print driver negotiates or determines the location, identification and capabilities of each printer 70 which is within IR/RF transmission range of the submitting device 20, and will make this information available to the user. Once the print driver has been loaded into the submitting device 20, a print job can be initiated.

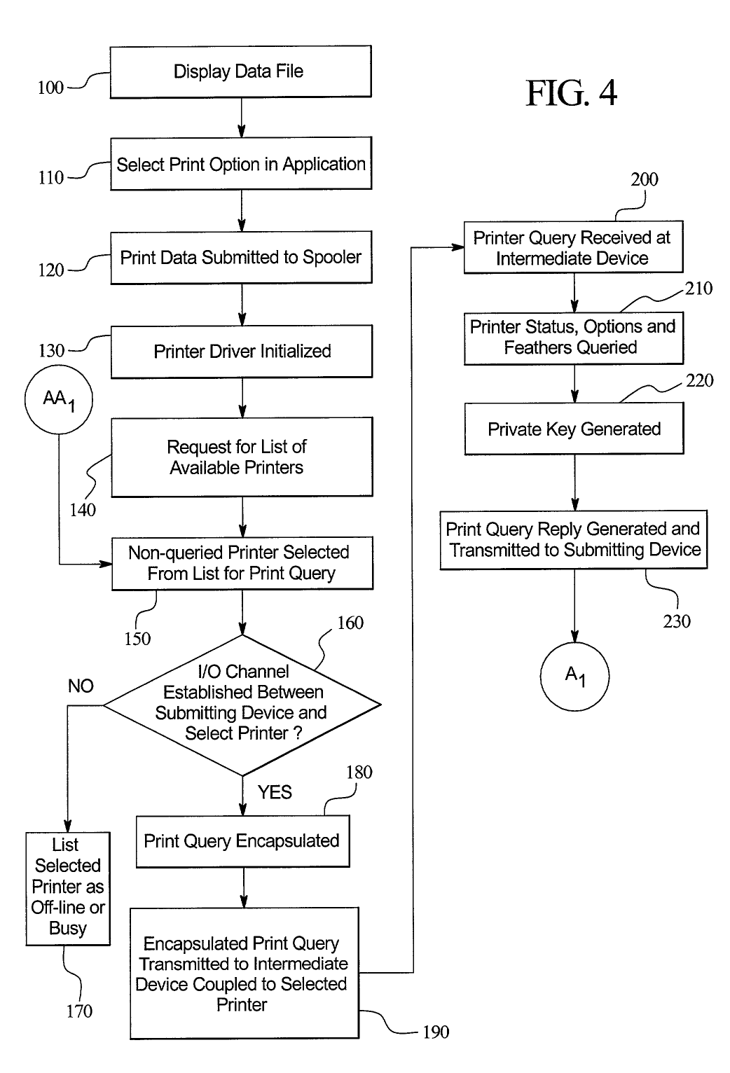

FIG. 4 is a flow diagram demonstrating the preferred steps involved in selecting a data file to print. Typically, this is accomplished by first displaying in step 100 the data file using an application (e.g., a word processing program or the like), and then selecting the application's “Print Option” in step 110. After the “Print Option” has been selected, the application submits the print data to the submitting device's spooler in step 120. Upon receipt of the print data, the submitting device's spooler converts the print data to a raw format, and initializes the above-mentioned specialized print driver in step 130.

Once initiated, a request for available printing assemblies 40 is submitted to the submitting device's “Plug and Play” system in step 140. The list of available printing assemblies 40 is generated based on which printing assemblies 40 are within physical range, and are therefore capable of transmitting their “Plug and Play” identifier to the submitting device 20.

Once a list is generated, the print driver sequentially queries each listed printing assembly 40 in step 150. For each printing assembly 40 queried, the submitting device 40 first seeks in step 160 to establish an input/output (I/O) channel between the submitting device 20 and the printing assembly 40. If an I/O channel cannot be established, an error condition is noted in step 170 by the transport layer, and that printing assembly 40 is listed as either “offline” or “busy”. If an I/O channel is established, the print driver encapsulates the print query in a pre-selected format in step 180, and transmits the print query to the intermediate device 50 of the printing assembly 40 in step 190. By encapsulating the print query, access to the printing assembly 40 can be controlled. In general, when a printing assembly receives data which is in an unrecognized format, that data is ignored. Therefore, by encapsulating the query in a pre-selected format, only those users who are using the specialized print driver will be capable of communicating with the printing assemblies 40.

Once the print query is received by the printing assembly 40 in step 200, the status of the attached one or more printers 60 is queried in step 210, and a private key is generated in step 220 to allow the user to securely submit the print data to the printing assembly 40. Thereafter, a print query reply is generated and transmitted to the submitting device 20 in step 230. The print query reply includes information such as the availability of the printer, the printer's properties, the private key, the location of the printer, the forms of payment which are accepted, and the relevant print costs.

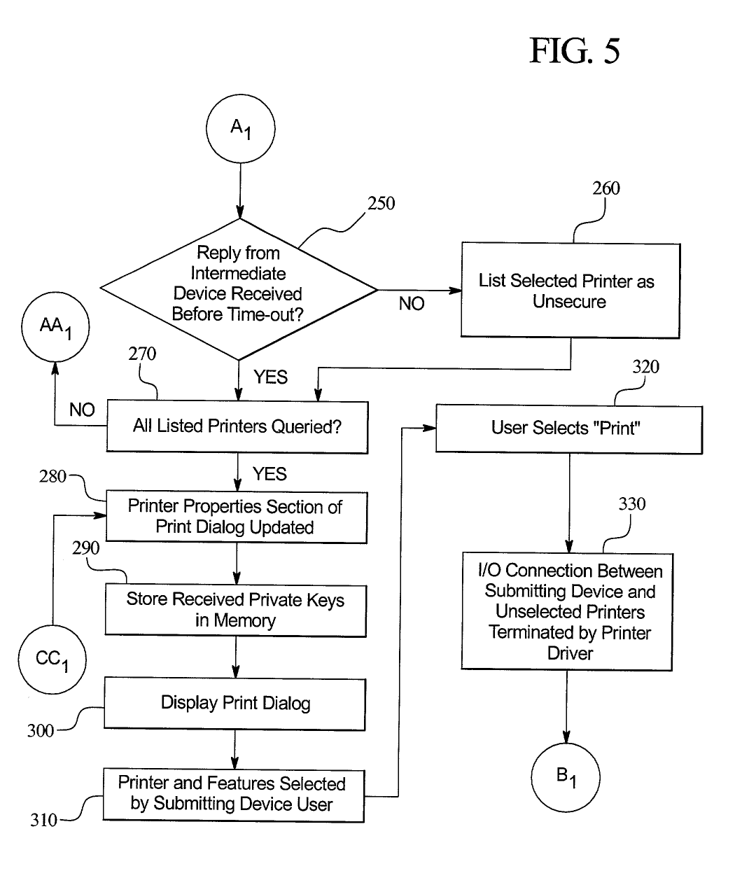

Referring to FIG. 5, a print query reply timeout is provided. If the print query reply is not received in step 250 before the expiration of the timeout, the queried printing assembly 40 is listed, in step 260, as unsecured. The user will not be prevented from submitting a print job to the queried printing assembly 40; however the user will be notified that any submitted print job would be transmitted over an unsecured I/O channel.

If it is determined that other non-queried printers remain on the list in step 370, a non-queried printer will be selected in step 150 and the print query process will be repeated. Once all of the printing assemblies 40 within range have been queried, the print driver updates the Printer Properties section of the Print dialog, in step 280, and stores all of the private keys in memory in step 290. Next, in step 300, the print dialog displays to the user a list of the available printing assemblies 40. Information that may be displayed in the print dialog for each printer listed includes: the location of the printing assembly 40, the options and features for the attached printer 60, the relevant printing costs, and whether the printer 60 is secure or unsecured. From the list of available printing assemblies 40, the user, in step 310, selects the desired printing assembly 40 to which the print job will be submitted. Additionally, the user may also select the desired printing features (e.g., duplexing, color printing, number of copies, print resolution, and the like) before selecting the “Print” option in step 320. Once the desired printing assembly 40 is selected by the user, all I/O channels between the submitting device 20 and the unselected printing assemblies 40 are terminated by the print driver in step 330.

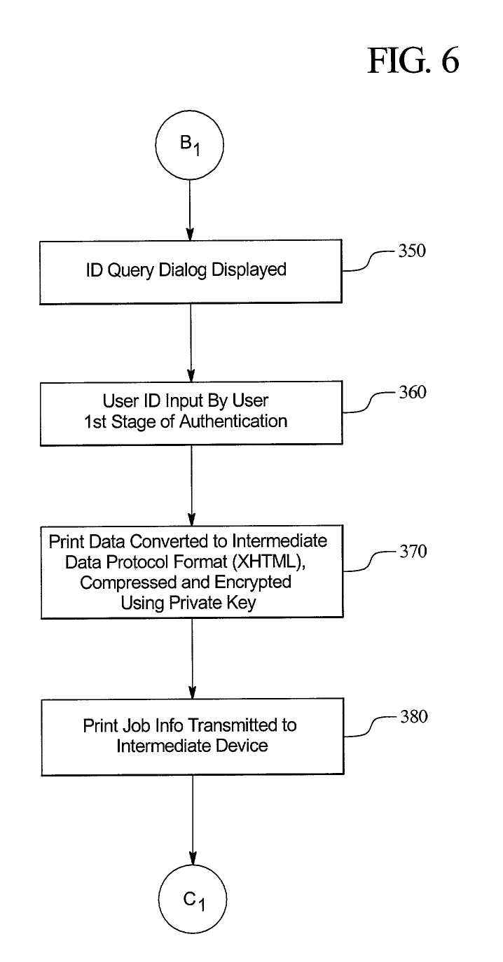

Referring to FIG. 6, after the desired printing assembly 40 has been selected, an ID query dialog is displayed on the screen display 28 by the print driver in step 350. The ID query dialog prompts the user to input an identifier (ID) which is specific to the user (e.g., the last four digits of a credit card number). Requiring the user to imput an ID at step 360 is the first of two steps by which the print job is linked to the user at the printing assembly 40, which will be more fully discussed below. These steps will collectively be referred to as “authentication” herein.

After an ID is inputted by the user, the print driver, at step 370, simultaneously converts the print data to an intermediate data protocol format, compresses the intermediate protocol print data, and encrypts the intermediate protocol data using the selected printing assembly's 40 private key. Converting the print data to an intermediate format ensures that, if the data is received by another wireless device which is within range of the submitting device 20, the transmitted data will not be recognized by the wireless device and therefore will be ignored. In other words, encrypting the print data substantially ensures the print data will not be captured or “snooped” during transmission by another wireless device.

In the preferred embodiment, the intermediate data protocol format is XHTML. However, other formats may be utilized, and it is preferred that the chosen format be standardized for well formness (the standard is written so that a receiving device cannot misinterpret the data received) and be formatted in UTF-8 (therefore making the format forwards and backwards capable).

Next, the print job information is transmitted in step 380 to the selected printing assembly 40. This print job information includes the printer features selected (e.g., the number of copies, the number of pages to be printed, and the user ID).

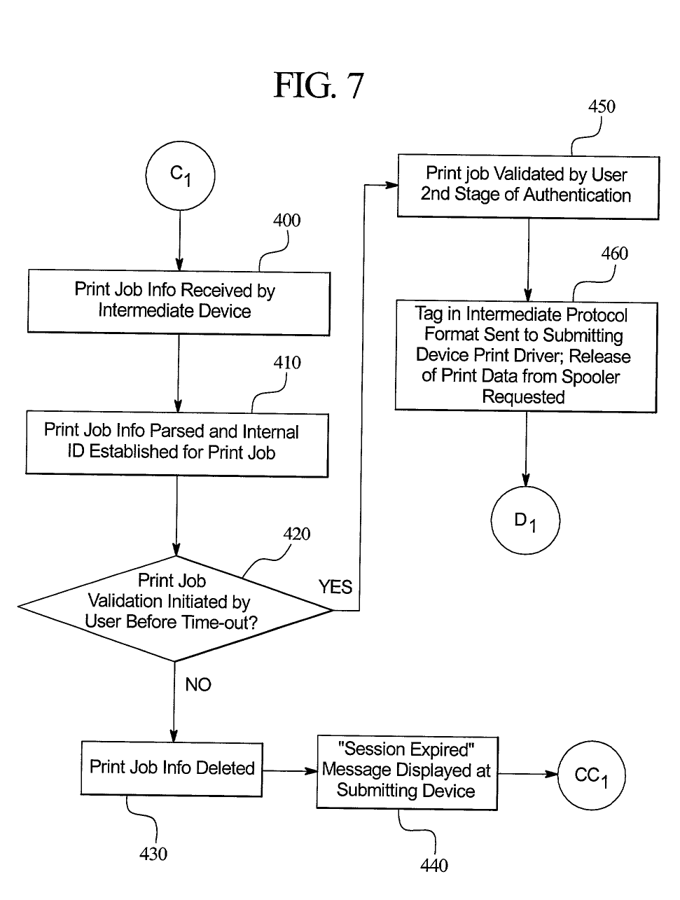

As shown in FIG. 7, once the print job information has been received by the selected printing assembly's intermediate device 50 in step 400, the print job information is parsed and an internal ID is established for that particular print job in step 410. The internal ID may include the contemplated debit amount based on the number of pages to be printed and the print features selected.

An administrator determinable validation timeout also is provided. If the user fails to initiate validation of the print job in step 420, as described hereinbelow, before the expiration of the timeout, the print job information is deleted in step 430. Thereafter, a “session expired” message is displayed in step 440 at the submitting device 20 alerting the user that the print job information must be re-transmitted. After re-transmitting the print job information, the user repeats the above process of submitting the print job to a selected printer until the printing job is validated as described below.

Validation is step two of the authentication process. During validation, the user in step 450 interacts with the validation device 80 thereby linking the user's physical presence at the printing assembly 40 with the print job information, and therefore the user ID. This ensures that the print data will not be printed before the user is prepared to claim the printed document, and ensures that the proper print job is released to the proper user.

In one contemplated embodiment, the validation device is a magnetic card reader. In such an embodiment, when the above-mentioned ID query dialog prompts the user to input an ID, that ID would be linked to a magnetic card (e.g., the last four digits of a credit card, or a pre-assigned number on a pre-paid or “stored value” card or the like). When the relevant magnetic card is passed through the magnetic card reader or “swiped”, information supplied from the magnetic strip permits the printing assembly 40 to automatically link the print job information with the magnetic card, and therefore the user.

Alternate embodiments are contemplated wherein the validation device includes an RF receiver. In such an embodiment, each user is provided with a corresponding RF transmitter that is assigned an ID and is capable of being identified separate and apart from all other RF transmitters. Upon receiving a signal from the RF transmitter, the printing device 40 checks that signal against the logged user ID's. If the received signal matches a logged ID, then that print job is validated.

Where the printing assembly 40 is operating in an accountable mode (where printing is supplied at a cost to the user), payment for the print job would also be accomplished at the validation device 80. As noted earlier, the printing assembly 40 calculates the contemplated debit amount based on the number of pages to be printed and the print features selected. Where a magnetic card reader is employed, payment for the print job could be charged against or debited to the account linked to the magnetic card swiped. It is contemplated that a payment authorization device (not shown) be linked to or integrated with the validation device 80 to ensure that the user is authorized to charge to or debit the linked account. Such a payment authorization device may be a keypad or keyboard for inputting a password, a biometric device such as a fingerprint reader, a handwritten signature reader, or a “smart-card” interface. It is also appreciated that payment may be made at the submitting device.

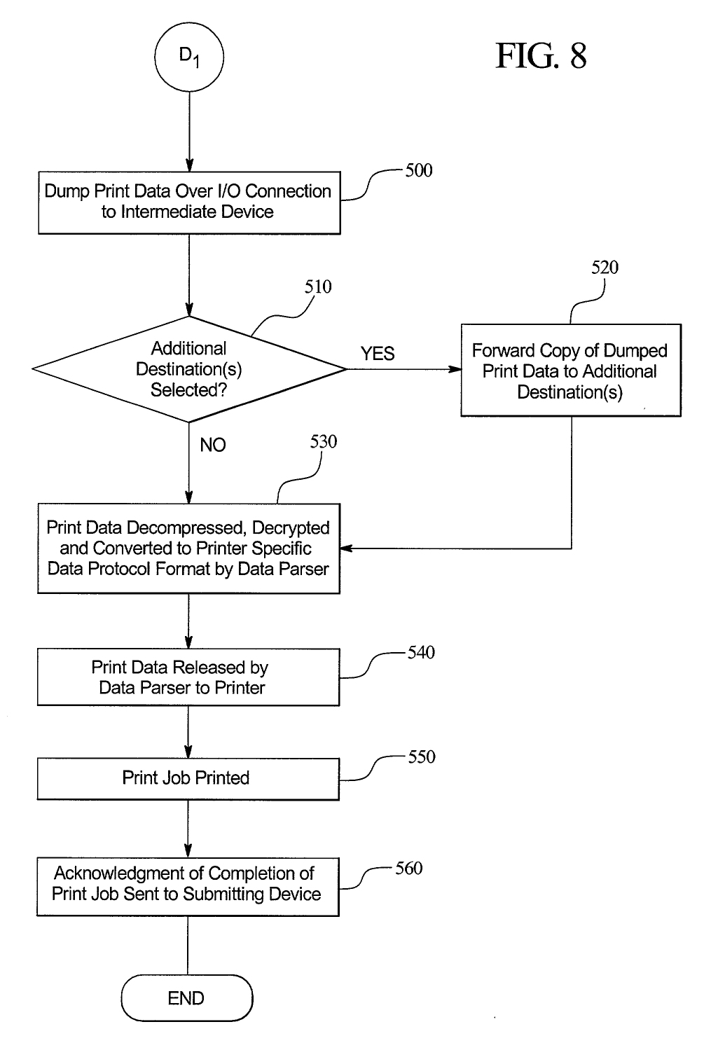

Referring again to FIG. 7, once the print job has been validated, therefore completing the authorization process, the intermediate device 50 in step 460 transmits a “tag” to the submitting device 20 prompting the submitting device's specialized print driver to release the print data from the submitting device's spooler. As described in FIG. 8, the print data, in step 500, is then dumped over the I/O connection to the intermediate device 50.

A “multiple-destination” step 510 may be implemented wherein the user is given the option of forwarding a copy of the intermediate print data file to one or more additional destinations in step 520. Such destinations may include, but are not limited to, additional printing assemblies, an authorized electronic mail or “e-mail” account, a facsimile machine, an unsecured printer, or any other device to which the data file can be transmitted. This feature is initiated by the user via the Printer Properties section of the Print dialog. During the aforementioned dumping of the print data over the I/O connection to the intermediate device 50, a copy of the print data would be forwarded from the intermediate device 50 of the selected printing assembly 40 to the selected additional destination via a dial-up connection or network-style connection, or via an IR and/or RF transmission.

After a copy of the print data is copied and forwarded to the selected additional destination, the print data is routed to the data parser of the selected printing assembly 40 where, in step 530, it is simultaneously decompressed, decrypted and converted to the attached printer's 70 data protocol format (e.g., PCL5, PostScript, ProPrinter, PPDS, UTF-8 and the like). Thereafter, in step 540, the print data is released by the data parser to the printer 70. Upon completion of the print job in step 550, the intermediate device 50 transmits an acknowledgment to the submitting device 20 in step 560 which, in turn, displays a notification to the user that the print job has been printed.

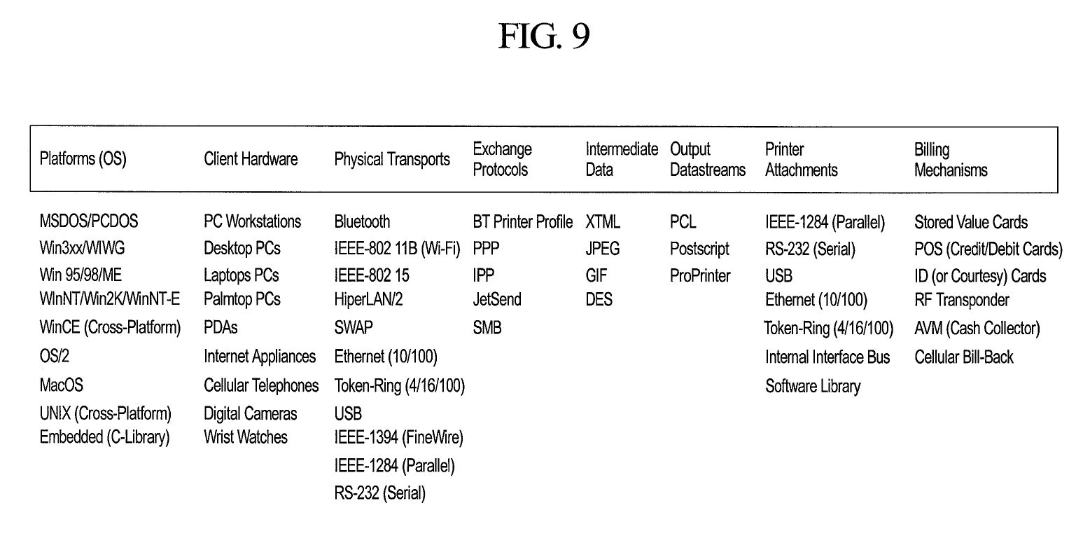

As shown in FIG. 9, the system 10 is useable with a multitude of combinations of: Platforms (Operating Systems); Client Hardware; Physical Transports; Exchange Protocols; Intermediate Data; Output Datastreams; Printer Attachments; and Billing Mechanisms. In particular, the Platforms may include: MSDOS/PCDOS; Windows3.xx/WfWG; Windows 95/98/ME/2000/XP; Windows NT/Windows2K/Windows NT-E; Windows CE (Cross-Platform); OS/2; MacOS; UNIX (Cross Platform); and Embedded (C-Library). The client hardware may include: PC Workstations; Desktop PCs; Laptop PCs; Palmtop PCs; PDAs; Pocket PCs; 2 way text pagers; Internet Appliances; Cellular Phones; Digital Cameras; and Wrist Watch pagers/cameras.

The physical transports may include: Bluetooth; IEEE-802.11B (Wi-Fi); IEEE-802.15; 802.11a; HiperLAN/2; SWAP; Ethernet (10/100); Token-Ring (4/16/100); USB; IEEE-1394 (FireWire); IEEE-1284 (Parallel); RS-232 (Serial); and the Internet. Exchange protocols can include: BT Printer Profile; PPP; IPP; JetSend; and SMB. The intermediate data format can include: XTML; JPEG; GIF; and DES. Output datastream formats can include: PCL; PostScript; ProPrinter; ESC/P; PPDS; UTF-8 (Generic); TIFF and SLEEK. Printer attachments can include: IEEE-1284 (Parallel); RS-232 (Serial); USB; Ethernet (10/100); Token-Ring (4/16/100); Internal Interface Bus; and, Software Library. The billing mechanisms can include: Stored Value Cards; POS (Credit Debit Cards); Automatic Teller Machines (ATMs) ID or Courtesy Cards; Internet Bill-Back; RF Transponders; AVM (Cash Collector) and Cellular Bill-Back.

The invention is hereby claimed as follows:

1. A system for wirelessly transmitting data stored in a submitting device comprising:
a submitting device;
means for converting the data into an intermediate data protocol format;
a peripheral device;
means for converting the data from the intermediate data protocol format to a format recognized by the peripheral device; and
means for wirelessly communicating between the submitting device and the peripheral device.

2. The system of claim 1 wherein the peripheral device is a printer.

3. The system of claim 2 wherein the intermediate data protocol format is XHTML.

4. The system of claim 1 wherein the means for communicating comprises an IR/RF transmitter/receiver associated with the submitting device and an IR/RF transmitter/receiver associated with the peripheral device.

5. The system of claim 1 wherein the means for converting the data into an intermediate data protocol format comprises a peripheral device driver.

6. The system of claim 5 wherein the means for converting the data from the intermediate data protocol into a format recognized by the peripheral device comprises an intermediate device associated with the peripheral device.

7. The invention of claim 1 wherein said data is encrypted.

8. A system for wirelessly transmitting data stored in a submitting device comprising:
a submitting device;
a peripheral device;
means for wirelessly communicating between the submitting device and the peripheral device;
means for converting data into a format recognized by the peripheral device; and
means for validating the transmission of the data.

9. The system of claim 8 wherein the means for validating comprises a magnetic card reader.

10. The system of claim 8 wherein the means for converting the data comprises a peripheral device driver associated with the peripheral device and an intermediate device associated with the peripheral device.

11. The system of claim 8 wherein the peripheral device is a printer.

12. The system of claim 8 wherein said data is encrypted.

13. A system for wirelessly transmitting data to a peripheral device, the system comprising:
a submitting device comprising:
a memory portion;
a peripheral device driver for determining the location, identity and capabilities of the peripheral device;
means for converting data stored in the memory portion to an intermediate data protocol format; and
means for wirelessly transmitting and receiving the data; and
a peripheral assembly comprising:
the peripheral device;
means for wirelessly transmitting and receiving the data to and from the submitting device; and
an intermediate device for converting the data received from the submitting device from the intermediate data protocol format to a format acceptable by the peripheral device.

14. The system of claim 13, wherein the peripheral assembly further comprises a validation device.

15. The system of claim 14, wherein the validation device is a magnetic card reader.

16. The system of claim 13, wherein the peripheral device is a printer.

17. The system of claim 13, wherein the system further includes means for monitoring the printing charges.

18. The system of claim 13, wherein the monitoring means includes means for charging the user for the data printed.

19. The system of claim 13, wherein the system further includes means for encrypting the data transmitted from said submitting device.

20. The system of claim 19, wherein the encrypting means comprises a public key embedded in the print driver and a private key generated by the intermediate device.

21. The system of claim 13, wherein the means for wirelessly transmitting and receiving data is an IR/RF receiver/transmitter.

22. The system of claim 13, wherein the intermediate device is a wireless print server dongle.

23. A printing system comprising:
a submitting device comprising:
a memory portion;
a print driver for determining the location, identity and capabilities of the printers;
means for converting data stored in the memory portion to an intermediate data protocol format; and
means for wirelessly transmitting and receiving the data; and
a printing assembly comprising:
a printer;
means for wirelessly transmitting and receiving the data to and from the submitting device; and
an intermediate device for converting the data received from the submitting device from the intermediate data protocol format to a format acceptable by the printer.

24. The system of claim 23, wherein the peripheral assembly further comprises a validation device.

25. The system of claim 23, wherein the validation device is a magnetic card reader.

26. The system of claim 23, wherein the peripheral device is a printer.

27. The system of claim 23, wherein the system further includes means for monitoring the printing charges.

28. The system of claim 23, wherein the monitoring means includes means for charging the user for the data printed.

29. The system of claim 23, wherein the system further includes means for encrypting the data transmitted from said submitting device.

30. The system of claim 29, wherein the encrypting means comprises a public key embedded in the print driver and a private key generated by the intermediate device.

31. The system of claim 23, wherein the means for wirelessly transmitting and receiving data is an IR/RF receiver/transmitter.

32. The system of claim 23, wherein the intermediate device is a wireless print server dongle.

33. A system for printing data stored in a submitting device comprising:
the submitting device;
means for converting the data stored in the submitting device to an intermediate data protocol format;
means associated with the submitting device for wirelessly transmitting and receiving the data;
means for encrypting the data transmitted;
a printer;
means associated with the printer for wirelessly transmitting and receiving the data;
means for converting the data from the intermediate data protocol format to a format that allows the printer to print the data; and
means for validating the printing.

34. A method for printing print data from a user's submitting device having a print driver to a printer of a printing assembly comprising the steps of:
selecting the print data from the submitting device to send to the printing assembly;
initiating the print driver of the submitting device;
establishing communication between the submitting device and one or more printing assemblies;
transmitting a print query from the submitting device to the one or more printing assemblies;
transmitting a reply to the print query from the one or more printing assemblies;
displaying printing information on the submitting device about the one or more printing assemblies;
selecting a printing assembly from the one or more printing assemblies;
converting the print data to an intermediate data protocol format;
transmitting the print data from the submitting device to the selected printing assembly;
converting the print data to a printer recognizable format; and
printing the print data.

35. The method of claim 34, further comprising the step of determining whether the queried printing assemblies are secure.

36. The method of claim 34 further comprising the step of encrypting the print data prior to transmitting the print data to the selected printing assembly.

37. The method of claim 34, wherein the intermediate data protocol format is XHTML.

38. The method of claim 34 further comprising the step of transmitting information related to the selected print data from the selected printing assembly to the submitting device.

39. The method of claim 34 further comprising the step of validating the printing to ensure that the printed data is associated with the proper submitting device.

40. The method of claim 39, wherein the validating step includes a magnetic card reader.

41. The method of claim 39, wherein the submitting device includes a RF transmitter/receiver for transmitting a unique identifier to the printing assembly.

42. The method of claim 34, further comprising the step of transmitting the print data to an alternate destination.

43. The method of claim 34, further comprising the step of transmitting an acknowledgement that the print data has been printed on the printing assembly to the submitting device.

44. The method of claim 34, further comprising the step of querying the user for a user ID upon selecting the selected printing assembly.

45. The method of claim 44 further comprising the step of transmitting the user ID to the selected printing assembly.

46. The method of claim 34, wherein the print query reply comprises information on the availability of the printer, the printer's properties, the location of the printer, the forms of payment accepted, and the print costs.

47. The method of claim 34, wherein the method further comprises the step of timing the amount of time to transmit the print query reply.

48. The method of claim 47, wherein the timing step further comprises the step of notifying the user that the printer is unsecured if the print query reply is not transmitted within a preset time.

49. The method of claim 34 which further comprises the step of encrypting the data.

50. A method for transmitting data from a submitting device to a peripheral device comprising the steps of:
selecting the data to transmit;
wirelessly communicating between the submitting device and the peripheral device;
selecting the peripheral device from at least one peripheral device;
converting the data into a format recognized by the peripheral device; and
transmitting the data from the submitting device to the peripheral device.

51. The method of claim 50 further comprising the step of encrypting the data prior to transmitting the data to the peripheral device.

52. A method for printing data transmitted from a wireless device comprising the steps of:
selecting the data to print;
communicating between the wireless device and at least one printer;
selecting a printer from the at least one printer to print the data;
converting the data to an intermediate data protocol format;
transmitting the print data to the selected printer;
converting the data from the intermediate data protocol format to a format recognized by the printer; and
printing the data.

53. The method of claim 52 which further comprises the step of validating the printing to ensure that the printed data is associated with the correct wireless device.

54. The method of claim 52 which further comprises the step of encrypting the data.
